(19) United States
(12) Patent Application Publication
(10) Pub. No.: US 2007/0066099 A1
(43) Pub. Date: Mar. 22, 2007

(54) RIGID PRINTED CIRCUIT BOARD ASSEMBLY FOR OPTICAL PICKUP

(76) Inventor: Li-Dong Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,606

(22) Filed: Apr. 11, 2006

(30) Foreign Application Priority Data
Sep. 20, 2005 (CN) 200510037443.9

(51) Int. Cl. H01R 12/00

(52) U.S. Cl. 439/80

(57) ABSTRACT

A rigid PCB assembly for an optical pickup includes a first rigid PCB, a second rigid PCB electrically connected to the laser diode, and a plurality of enameled wires electrically interconnecting the first PCB and the second rigid PCB.

### FIELD OF THE INVENTION

This invention relates to a rigid printed circuit board (PCB) assembly and, more particularly, to a rigid PCB assembly for an optical pickup.

### DESCRIPTION OF RELATED ART

Flexible printed circuit board (PCB) is a kind of bendy PCB which is suitable for used in narrow space. It is widely used in various electronic apparatuses such as optical pickups, cell phones for providing electrical connections.

Referring to FIG. 4, a general optical pickup 20 is illustrated. The optical pickup 20 includes a laser diode (not shown), a flexible PCB 24 and a reinforcing plate assembly 26. The laser diode has a plurality of electrodes 220 protruding therefrom. The flexible PCB 24, which is integrally formed, includes a first portion 240 and a second portion 242. The first portion 240 and the second portion 242 are electrically interconnected via a plurality of printed wires (not shown) on the flexible PCB 24. The reinforcing plate assembly 26 includes a first plate 260 and a second plate 262. The first portion 240 of the flexible PCB 24 is attached to and supported by the first plate 260. The second portion 242 of the flexible PCB 24 is attached to and supported by the second plate 262. The electrodes 220 are soldered to the first portion 240. The second portion 242 is electrically connected to other circuit components (not shown). Signals thus can be transmitted between the laser diode and other circuit components. However, special requirements for manufacturing the flexible PCB 24 induce extra costs. Furthermore, the flexible PCB 24 is liable to be deformed without support of the reinforcing plate assembly 26.

In order to overcome the above-described shortcoming, another kind of PCB assembly 28 as shown in FIG. 5 has been developed. This kind of PCB assembly 28 includes a flexible PCB 280 and a rigid PCB 282. The flexible PCB 280 and the rigid PCB 282 respectively have a plurality of first terminals 284 and second terminals 286. A laser diode (not shown) may be soldered to the flexible PCB 280. The rigid PCB 282 is electrically connected to other circuit components (not shown). The first terminals 284 are directly soldered onto the second terminals 286 to get electrical connections between the flexible PCB 280 and the rigid PCB 282. It is well known that rigid PCBs are generally cheaper than flexible PCBs, thus the cost of the PCB assembly 28 is lowered relative to that of the flexible PCB 24. However, the cost cannot be greatly cut down because of reservation of the flexible PCB 280. The flexible PCB 280 is prone to be deformed because of high temperature when the first terminals 284 are directly soldered onto the second terminals 286 with soldering paste (not shown).

Accordingly, what is needed is a rigid PCB assembly which is economical and convenient for manufacturing, and an optical pickup employing the same.

### SUMMARY OF INVENTION

A rigid PCB assembly for an optical pickup includes a first rigid PCB, a second rigid PCB electrically connected to the laser diode, and a plurality of enameled wires electrically interconnecting the first rigid PCB and the second rigid PCB.

Other advantages and novel features will become more apparent from the following detailed description of preferred embodiments when taken in conjunction with the accompanying drawings, in which:

### BRIEF DESCRIPTION OF DRAWINGS

Many aspects of the present rigid printed circuit board (PCB) assembly can be better understood with reference to the following drawings. The components in the drawings are not necessarily to scale, the emphasis instead being placed upon clearly illustrating the principles of the present rigid PCB assembly.

FIG. 1 is a schematic view of a rigid PCB assembly in accordance with an embodiment, with a plurality of enameled wires thereof;

FIG. 2 is an enlarged sectional view of the enameled wire;

FIG. 3 is an isometric view of an optical pickup with the rigid PCB assembly of FIG. 1 being partially attached thereto;

FIG. 4 is a schematic view of a general PCB assembly; and

FIG. 5 is an isometric view of an optical pickup with another general flexible PCB.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION

Reference will now be made to the drawing figures to describe the embodiments of the present rigid printed circuit board (PCB) assembly in detail.

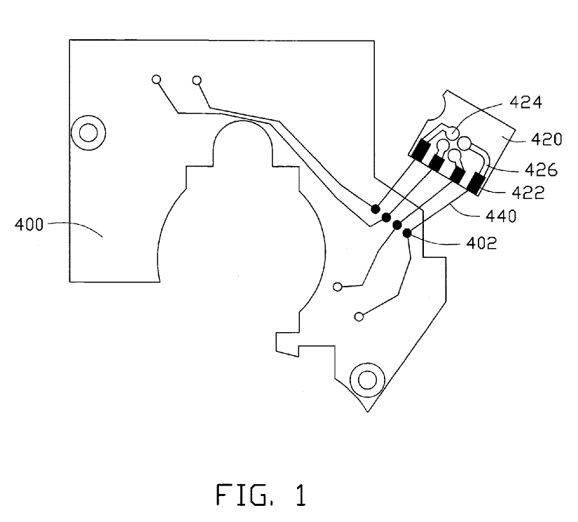

Referring to FIG. 1, a rigid printed circuit board (PCB) assembly 40 according to an embodiment is illustrated. The rigid PCB assembly 40 includes a first rigid PCB 400, a second rigid PCB 420 and a plurality of enameled wires 440. The first rigid PCB 400 and the second rigid PCB 420 are electrically interconnected via the enameled wires 440.

The first rigid PCB 400 includes a plurality of first terminals 402. The second rigid PCB 420 includes a plurality of second terminals 422 corresponding to the first terminals 402, a plurality of third terminals 424, and a plurality of printed wires 426 for interconnecting the second terminals 422 and the third terminals 424.

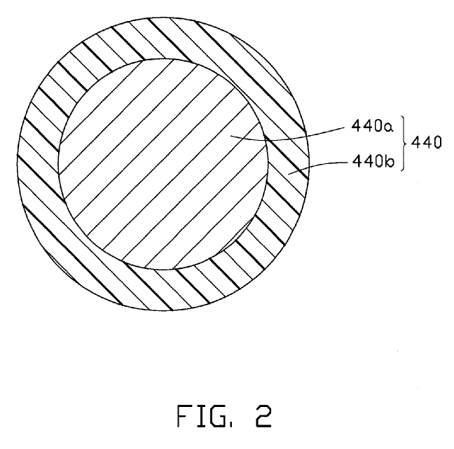

The enameled wires 440 are separated from each other. Referring to FIG. 2, each enameled wire 440 includes a core wire 440a, an insulating film 440b coating around an outer surface of the core wire 440a. The core wire 440a can be made of copper, copper alloy or the like, and the insulating film 440b can be made of polyester resin or the like.

A process of soldering each enameled wire 440 to the first rigid PCB 400 and the second rigid PCB 420 is: stripping the insulating film 440b around two opposite ends of each enameled wire 440, using a carbon dioxide laser or the like before soldering, and then respectively soldering the core wires 440a to the corresponding first terminals 402 and the corresponding second terminals 422 with soldering paste (not labeled). The first rigid PCB 400 and the second rigid PCB 420 are thus electrically interconnected.

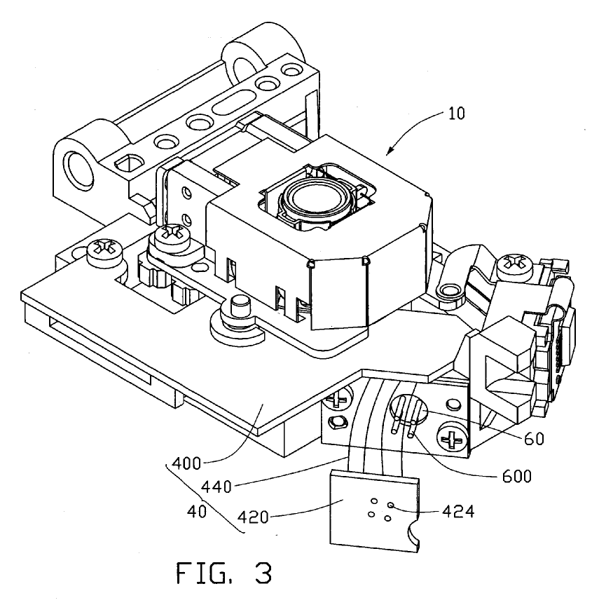

Referring to FIG. 3, an optical pickup 10 employing the rigid PCB assembly 40 is illustrated. The optical pickup 10 includes a laser diode 60 which has a plurality of electrodes 600. The second rigid PCB 420 is electrically connected to the laser diode 60 by means of soldering the electrodes 600 to the third terminals 424. The first rigid PCB 400 is electrically connected to other circuit components (not shown). Control signals can thus be transmitted between the laser diode 60 and the circuit components.

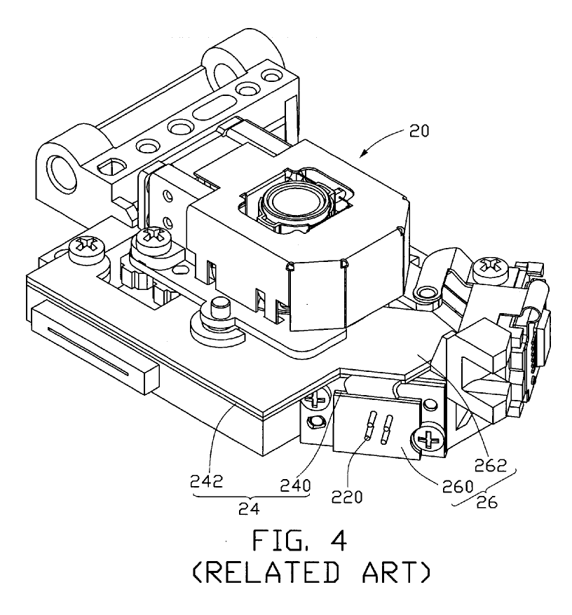

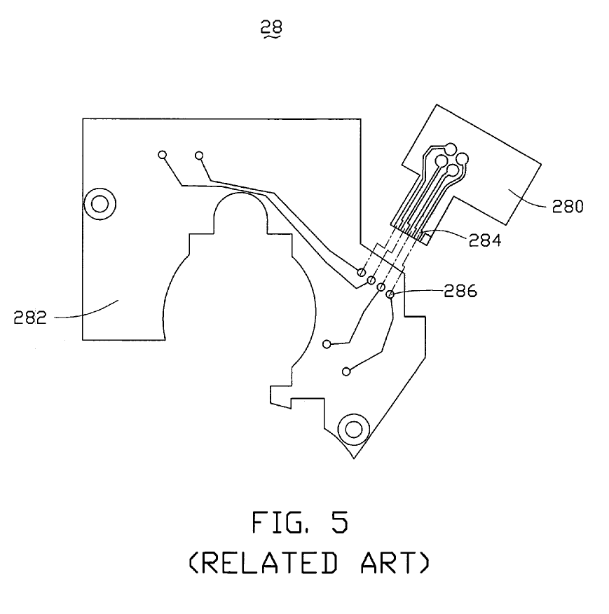

The rigid PCB assembly 40 is more economical than either the general flexible PCB 24 (shown in FIG. 4) or the general PCB assembly 28 (shown in FIG. 5). The enameled wires 440 can be easily and reliably soldered. The first rigid PCB 400 and the second rigid PCB 420 can be interconnected via the enameled wires 440 without deformation because of their high thermal resistance characteristics. Additionally, the reinforcing plate assembly 26 (shown in FIG. 4) is not necessary when being assembled in the optical pickup 10 because of the first rigid PCB 400 and the second rigid PCB 420 are rigid enough to support themselves. Furthermore, it is easy to solder the enameled wires 440 because the uniform requirement of spreading the soldering paste is properly lowered.

It is noted that various electronic apparatuses such as notebook computers, mobile phones, printers besides the optical pickup 10 can employ the rigid PCB assembly 40.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A rigid printed circuit board (PCB) assembly for an optical pickup including a laser diode, the rigid PCB assembly comprising:
a first rigid PCB;
a second rigid PCB electrically connected to the laser diode; and
a plurality of enameled wires electrically interconnecting the first rigid PCB and the second rigid PCB.

2. The rigid PCB assembly as claimed in claim 1, wherein the first rigid PCB includes a plurality of first terminals, the second rigid PCB includes a plurality of second terminals corresponding to the first terminals, the first terminals and the second terminals are electrically connected to each other via the enameled wires.

3. The rigid PCB assembly as claimed in claim 2, wherein each of the enameled wires includes a first end and an opposite second end, the first ends and the corresponding second ends are respectively soldered to the fist terminals and the corresponding second terminals.

4. The rigid PCB assembly as claimed in claim 2, wherein the laser diode has a plurality of electrodes, the second rigid PCB further includes a plurality of third terminals corresponding to the second terminals for electrically connecting the electrodes, the third terminals are electrically connected to the second terminals via a plurality of printed wires on the second rigid PCB.

5. The rigid PCB assembly as claimed in claim 3, wherein the electrodes are soldered to the third terminals.

6. The rigid PCB assembly as claimed in claim 2, wherein the enameled wires separate from each other.

7. An optical pickup comprising:
a laser diode; and
a rigid PCB assembly including a first rigid PCB, a second rigid PCB electrically connected to the laser diode, and a plurality of enameled wires electrically interconnecting the first rigid PCB and the second rigid PCB.

8. The optical pickup as claimed in claim 7, wherein the first rigid PCB includes a plurality of first terminals, the second rigid PCB includes a plurality of second terminals corresponding to the first terminals, the first terminals and the second terminals are electrically connected to each other respectively via the enameled wires.

9. The optical pickup as claimed in claim 8, wherein each of the enameled wires includes a first end and an opposite second end, the first ends and the corresponding second ends are respectively soldered to the fist terminals and the corresponding second terminals.

10. The optical pickup as claimed in claim 8, wherein the laser diode has a plurality of electrodes, the second rigid PCB further includes a plurality of third terminals corresponding to the second terminals for electrically connecting the electrodes, the third terminals are electrically connected to the second terminals via a plurality of printed wires on the second rigid PCB.

11. The optical pickup as claimed in claim 9, wherein the electrodes are soldered to the third terminals.

12. The optical pickup as claimed in claim 8, wherein the enameled wires completely separate from each other.

13. An electronic apparatus comprising:
a rigid PCB assembly including a first rigid PCB, a second rigid PCB, and a plurality of enameled wires electrically interconnected the first rigid PCB and the second rigid PCB.

14. The electronic apparatus as claimed in claim 13, wherein the first rigid PCB includes a plurality of first terminals, the second rigid PCB includes a plurality of second terminals corresponding to the first terminals, the first terminals and the second terminals electrically connects to each other respectively via the enameled wires.

15. The electronic apparatus as claimed in claim 14, wherein each of the enameled wires includes a first end and an opposite second end, the first ends and the corresponding second ends are respectively soldered to the fist terminals and the corresponding second terminals.

16. The electronic apparatus as claimed in claim 14, wherein the enameled wires separate from each other.
